(19) United States
(12) Patent Application Publication
(10) Pub. No.: US 2014/0188553 A1
(43) Pub. Date: Jul. 3, 2014

(54) Quota Cell Priority Determination to Match a Panelist to a Market Research Project

(71) Applicant: e-Rewards, Inc., Plano, TX (US)

(72) Inventors: James Sterling Shapiro Harter, Lantana, TX (US); Stephen Allen Myers, Dallas, TX (US); Eric Steven Herfield, Plano, TX (US); Jeremy Scott Antoniuk, Allen, TX (US); Melanie Denise Courtright, Rowlett, TX (US); Daren Moneta, Dallas, TX (US); Peter David Flower, London (GB)

(21) Appl. No.: 13/733,075

(22) Filed: Jan. 2, 2013

(51) Int. Cl. G06Q 30/02

(52) U.S. Cl. CPC G06Q 30/0202
USPC 705/7.29

(57) ABSTRACT

A method of matching a panelist to a market research project includes assigning, by one or more computer processors, priorities to quota cells. The method additionally includes accessing, by the one or more computer processors, a set of the prioritized quota cells identified for the panelist. The method also includes selecting, by the one or more computer processors, one of the quota cells based at least in part on the priorities. The method further includes matching, by the one or more computer processors, the panelist to the market research project based on the selected quota cell.

### TECHNICAL FIELD

This disclosure is generally directed to matching a panelist to a market research project. This disclosure is specifically directed to quota cell priority determination to match a panelist to a market research project.

### BACKGROUND

Market research is an organized effort to gather information about markets or customers. Market research can include social and opinion research performed to systematically gather and interpret information about individuals or organizations using statistical and analytical methods and techniques of the applied social sciences to gain insight or support decision making. Viewed as an important component of business strategy, market research can be a key factor to obtain advantage over competitors. Market research provides important information to identify and analyze market need, market size, and competition.

Quantitative marketing research is the application of quantitative research techniques to the field of marketing. It has roots in both the positivist view of the world, and the modern marketing viewpoint that marketing is an interactive process in which both the buyer and seller reach a satisfying agreement on the “four Ps” of marketing: Product, Price, Place (location), and Promotion. As a social research method, it typically involves the construction of questionnaires and scales. People who respond (respondents) are asked to complete the survey. Marketers use the information so obtained to understand the needs of individuals in the marketplace, and to create strategies and marketing plans.

In market research, projects are defined for supplying a market research sample to a customer having a survey that needs to be completed by panelists having certain targeted attributes. Generally speaking, a project has a deadline for survey completion, and a set of criteria to fulfill in terms of the targeted attributes. An example target attribute for a survey might be “includes owners of vehicle model X,” thus defining a requirement that 100% of panelists have this attribute. Another example target attribute for a survey might be “excludes drivers over age 40,” thus defining a requirement that 0% of panelists have the attribute of being over age 40.

On the other hand, other criteria for a project may involve quotas for certain demographics, such as 45%-55% male and 45%-55% female. These demographic quotas help prevent skew in the results, and are grouped together. For example, the aforementioned set of demographics defines a quota group for the project, with the % male and % female panelists each being a quota cell in that quota group. Another quota group might be defined as 45%-55% eastern US residents and 45%-55% western US residents. These quota groups may be independent of one another, in which case the customer does not mind if 100% of the male respondents are from the Eastern US, etc. Alternatively, the quota cells of a group may be “nested” (AKA “interlocked”), in which case two groups each having two quota cells may be replaced by a single quota group having four nested quota cells as follows: 22.5%-27.5% male, eastern US residents; 22.5%-27.5% female, eastern US residents; 22.5%-27.5% male, western US residents; 22.5%-27.5% female, western US residents. A project may have multiple quota groups, some of which may quota cells nested therein.

The task of supplying the sample for a project has previously been addressed by using a relational database to find panelists having attribute values that match the values of the targeted attributes of a project. In this sense, panelists may be potential respondents who have enrolled as panelists and therefore have one or more of their attribute values recorded in the relational database. It is envisioned that panelists may be members of one or more proprietary market research access panels, or may have been sourced elsewhere, such as dynamically sourced through a network of website properties or from a third party access panel. It is also envisioned that panelists may be newly enrolling or not yet enrolled panelists. For a particular project, the panelists having the attribute values are then sent emails that provide a link to a survey associated with that project. A panelist may respond to such an email after that panelist is no longer needed for that project. In the past, such a panelist may then be matched to another project having a high acceptance rate, in the same or similar way that newly enrolled panelists are handled. However, it would be advantageous to match returning panelists or newly enrolled panelists to projects having relatively low acceptance rates, thus making more effective use of the panelists. It would also be advantageous to make more efficient use of panelists who fail to qualify for a survey by rerouting such panelists to another survey. The present disclosure is directed toward providing such a solution.

### BRIEF SUMMARY

In some aspects, a method of matching a panelist to a market research project includes assigning, by one or more computer processors, priorities to quota cells. The method additionally includes accessing, by the one or more computer processors, a set of the prioritized quota cells identified for the panelist. The method also includes selecting, by the one or more computer processors, one of the quota cells based at least in part on the priorities. The method further includes matching, by the one or more computer processors, the panelist to the market research project based on the selected quota cell.

In other aspects, an apparatus for matching a panelist to a market research project has means for assigning, by one or more computer processors, priorities to quota cells. Additionally, the apparatus has means for accessing, by the one or more computer processors, a set of the prioritized quota cells identified for the panelist. Also, the apparatus has means for selecting, by the one or more computer processors, one of the quota cells based at least in part on the priorities. Further, the apparatus has means for matching, by the one or more computer processors, the panelist to the market research project based on the selected quota cell.

In additional aspects, a computer program product includes a non-transitory computer-readable medium that includes code for assigning, by one or more computer processors, priorities to quota cells. The computer-readable medium additionally includes code for accessing, by the one or more computer processors, a set of the prioritized quota cells identified for a panelist. The computer-readable medium also includes code for selecting, by the one or more computer processors, one of the quota cells based at least in part on the priorities. The computer-readable medium further includes code for matching, by the one or more computer processors, the panelist to a market research project based on the selected quota cell.

In other aspects, a market research apparatus has a memory that stores data relating to panelists and market research projects. The apparatus also has a processor configured to assign priorities to quota cells. The processor is additionally configured to access a set of the prioritized quota cells identified for the panelist. The processor is also configured to select one of the quota cells based at least in part on the priorities. The processor is further configured to match the panelist to the market research project based on the selected quota cell.

In further aspects, a method of finding a first data item within a set based on a second data item includes assigning, by one or more computer processors, priorities to criteria data items of the first data items, wherein the criteria data items represent criteria for matching the second data item to the first data items. The method additionally includes accessing, by the one or more computer processors, a set of the prioritized criteria data items identified for the second data items. The method also includes selecting, by the one or more computer processors, a first data item based at least in part on the priorities assigned to its respective criteria data items identified for the second data item. The method further includes matching the second data item to the first data item based on the selection.

In yet further aspects, an apparatus for finding a first data item within a set based on a second data item, includes means for assigning, by one or more computer processors, priorities to criteria data items of the first data items, wherein the criteria data items represent criteria for matching the second data item to the first data items. The apparatus additionally includes, means for accessing, by the one or more computer processors, a set of the prioritized criteria data items identified for the second data items. The apparatus also includes means for selecting, by the one or more computer processors, a first data item based at least in part on the priorities assigned to its respective criteria data items identified for the second data item. The apparatus further includes means for matching the second data item to the first data item based on the selection.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying FIGURES, in which:

FIG. 1 is a flow diagram illustrating a method of matching a panelist to a market research project in accordance with the present disclosure;

FIG. 2 is a block diagram illustrating an apparatus for matching a panelist to a market research project in accordance with the present disclosure;

FIG. 3 is a flow diagram illustrating a method of operation for a market research apparatus in accordance with the present disclosure;

FIG. 4A is a graphical representation illustrating a traffic pattern in accordance with the present disclosure;

FIG. 4B is a graphical representation illustrating a field schedule in accordance with the present disclosure;

FIG. 5 is a flow diagram illustrating a method of assigning a priority to a quota cell in accordance with the present disclosure; and

FIG. 6 is a block diagram illustrating a method of generating a score to be utilized in the method of FIG. 5 in accordance with the present disclosure.

### DETAILED DESCRIPTION

As will be further explained below, the present disclosure is generally related to finding a first data item within a set based on a second data item. For example, the one or more computer processors assign priorities to criteria data items of the first data items, and access a set of criteria data items identified for the second data item. The criteria data items represent criteria for matching the second data item to the first data items. Additionally, the one or more computers select a first data item based at least in part on the priorities assigned to their respective criteria data items identified for the second data item. Also, the one or more computers match the second data item to the first data item based on the selection. In some aspects, the one or more computers may assign priorities to the criteria data items based on one or more of scarcity of their respective first data items, schedules for finding their respective first data item; or scarcity of second data items that satisfy the criteria of the respective data items.

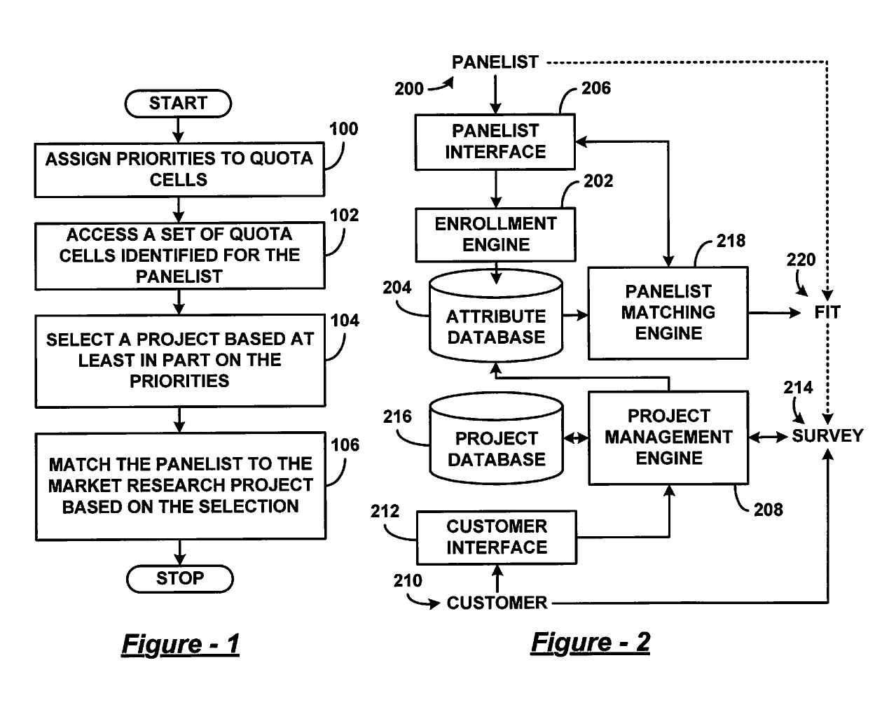

In particular aspects described below with reference to FIGS. 1-5, an example implementation is set forth that addresses the task of matching a panelist to a market research project. For example, in these aspects, the first data item represents a market research project, and the second data item represents a panelist. Additionally, in these aspects, the criteria data item represents a quota cell, and the scarcity of the first data items corresponds to percentage of progress, which correlates to the market research project being overly abundant if the percentage of progress is low. Thus, more abundant first data items may be found for second data items having attribute values that fulfill the criteria of the first data items. Further, in these aspects, schedules for finding the first data items may correspond to an effective field time or deadline for supplying the sample for the market research project. Yet further, in these aspects, scarcity of the first data items may correspond to scarcity of panelists having the attribute values that fulfill the criteria of the first data items.

It is envisioned that other implementations may address other tasks. For example, it is envisioned that other implementations may match medical patients to medications, treatments, and/or medical study opportunities. Additionally, it is envisioned that other implementations may match consumers to advertisements. Also, more generally, other implementations may match entities having known attributes to goods, services, or opportunities. One skilled in the art will readily apprehend how to extend the teachings of the present disclosure to these other implementations without undue experimentation.

Referring to FIG. 1, the present disclosure is directed to a solution to the problem of matching returning panelists or newly enrolled panelists to projects having relatively low acceptance rates, and of rerouting panelists who fail to qualify for one survey to another survey. Under the proposed solution, one or more computer processors may, at step 100, assign priorities to quota cells. The one or more computer processors may additionally, at step 102, access a set of quota cells identified for a panelist. The one or more computers may also, at step 104, select a market research project based at least in part on the priorities assigned to its respective quota cells identified for the panelist. The one or more computer processors may further, at step 106, match the panelist to the market research project based on the selection.

As described with reference to FIG. 2, the proposed solution for matching panelists to projects may be implemented by one or more components of an apparatus for matching a panelist 200 to a market research project. Such an apparatus may implement an enrollment engine 202 that enrolls the panelists 200 in an attributes database 204 by collecting attribute values of the panelist via a panelist interface 206. The attributes database 204 may include a relational database as will be readily understood by one skilled in the art. The relational database may be used for running queries that are not as time sensitive as a panelist rerouting operation. The attributes database 204 includes a graph database that relates panelists to profile parameter value vertices by edges, and that relates profile parameter value vertices to quota cell vertices by edges corresponding to Boolean expressions for satisfying quota cell criteria. This graph database may be employed for running queries in rerouting operations. Enrollment engine 202 may create and/or edit panelist vertices and/or the edges relating panelist vertices to profile parameter value vertices. Example graph database implementations are described in greater detail in co-pending U.S. patent application Ser. No. ______ entitled Using a Graph Database to Match Entities by Evaluating Boolean Expressions and filed concurrently herewith by the assignee of the present application on Jan. 2, 2013. The disclosure of the aforementioned U.S. patent application is incorporated by reference herein in its entirety for any purpose. The disclosure of the aforementioned U.S. patent application is attached hereto as Appendix A. Appendix A forms part of the application. Any features of any embodiments described in Appendix A may be combined with each other or combined with any embodiments within the description and/or any other Appendices attached hereto.

The apparatus may additionally implement a project management engine 208 that interacts with a customer 210 via a customer interface 212 to obtain information about a survey 212 implemented by the customer. As further explained below with reference to FIGS. 4-6, this customer interface 212 may also be adapted to serve as a central admin user interface that permits an administrator having secured privileges to edit parameters governing operation of the project management engine 208. As will be readily understood by one skilled in the art, project management engine 208 may collect information about a project for supplying a sample for the survey, including targeted attributes, demographic quotas, and a link to the electronic survey 214 hosted at the customer's website. One or more data objects representing the project may be instantiated and maintained by project management engine 208 in projects database 216. Project management engine 208 may additionally create and/or edit entries in attribute database 204 to record, for example, the profile parameter value vertices, the quota cell vertices, and the edges corresponding to Boolean expressions for satisfying quota cell criteria.

Project management engine 208 may also assign priorities to quota cells of projects based on one or more conditions, such as: scarcity of panelists having the profile parameter values that satisfy the quota cell criteria, which may be defined in terms of actual scarcity of such panelists in the database, or may be defined as a scarcity/value proxy based on pricing of quota cells that reflects scarcity of the panelists fulfilling the quota cell criteria; percentage of progress, which may be defined in terms of number of registered starts or completes for a quota cell, versus the total number of starts or completes scheduled to have been achieved according to a field schedule for filling that quota cell on or before the project completion deadline; and/or elapsed effective field time for completion of the project, with a factor being defined for use as a measure of priority based on percentage of completion. In this sense, effective field time may take into consideration the time of day, days of the week, etc. with respect to panelist behavior, and when panelists are more likely to be available. Such priority assignment is described in greater detail below with reference to FIGS. 4-6.

The computer-implemented process of matching panelists to projects may principally be carried out by a panelist matching engine 218. The panelist matching engine 218 may interact with the panelist 200 via the panelist interface 206, and access the attribute database 204, to obtain a fit 220 that matches the panelist 200 to a market research project associated with a survey 214. Accomplishing the fit 220 may result, for example, in the panelist 200 being redirected to a website of the customer 210 where the survey 214 is hosted.

Such matching of the panelist to a project is described in greater detail in co-pending U.S. patent application Ser. No. ______ entitled Priority-Weighted Selection to Match a Panelist to a Market Research Project and filed concurrently herewith by the assignee of the present application on Jan. 2, 2013. The disclosure of the aforementioned U.S. patent application is incorporated by reference herein in its entirety for any purpose. The disclosure of the aforementioned U.S. patent application is attached hereto as Appendix B. Appendix B forms part of the application. Any features of any embodiments described in Appendix B may be combined with each other and/or combined with any embodiments within the description and/or any other Appendices attached hereto.

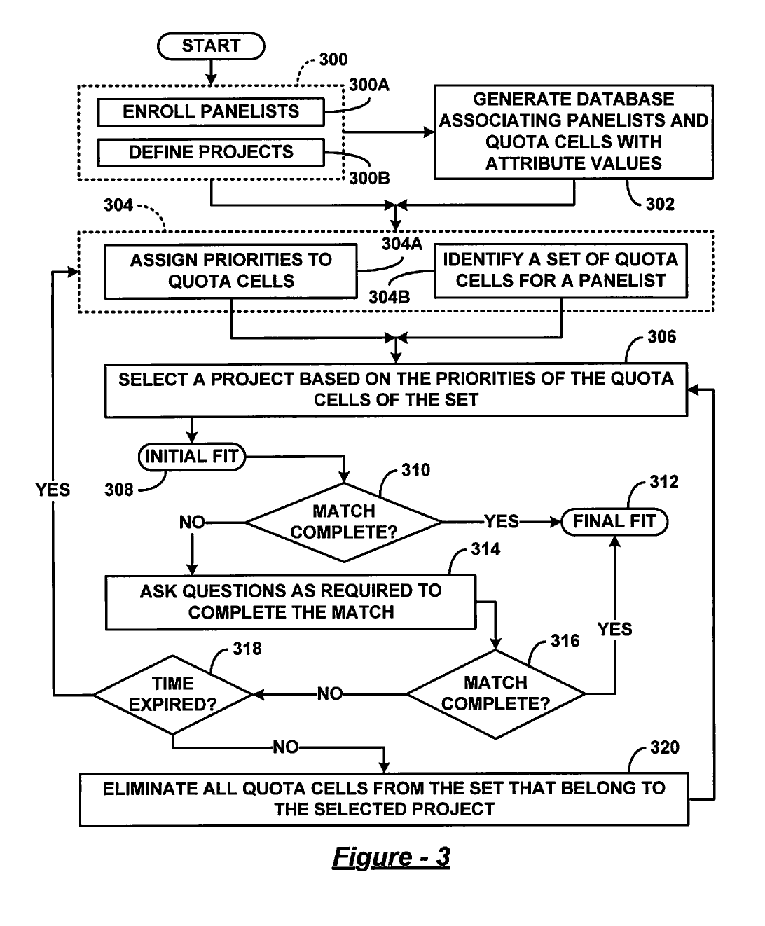

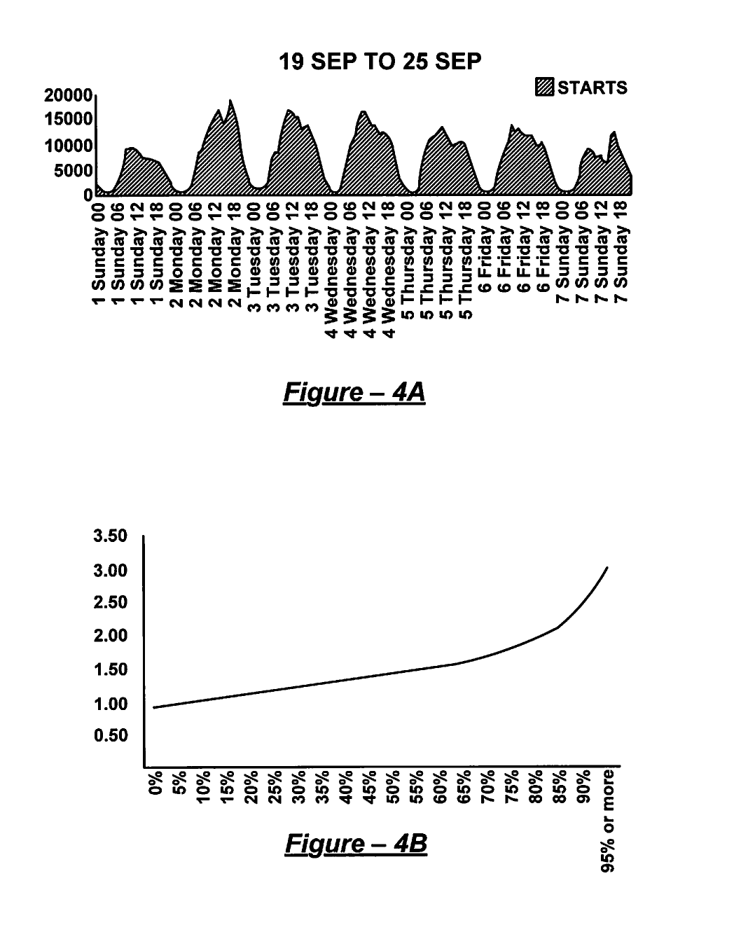

Turning now to FIG. 3, a method of operation for the market research apparatus may begin at step 300 by enrolling panelists at step 300A, and defining projects at step 300B. A database associating panelists and quota cells with attribute (i.e., profile parameter) values may be generated and/or updated at step 302. At step 304, priorities may be assigned to quota cells at step 304A, and a set of quota cells may be identified for a panelist at step 304B. At step 306, one of the market research projects may be selected based on the priorities of the quota cells identified for the panelist. This selection may result in an initial fit 308. However, it is possible, in some implementations, that the match is not a complete match.

An incomplete match may occur, for example, if no value for a profile parameter required by quota cell criteria has yet been recorded. Alternatively or additionally, an incomplete match may be determined based on a profile parameter value being expired (i.e., a sufficient amount of time having passed for a previous identification for the profile parameter value identification to no longer be current), thus permitting an incomplete match even if the same or another value for that parameter was previously identified. Further, an event based mechanism may be employed that enables an incomplete match to occur due to a recorded event in a panelist's life that would indicate that certain profile parameter values may no longer be current or correct. If it is determined, at step 310, that the match is complete, then the initial fit 308 may be considered a final fit 312. Otherwise, at step 314, questions may be asked as required to complete the match. Any identifications obtained at step 314 may be employed to dynamically update the panelist's profile. If it is determined, at step 316, that the match is now complete, then the result may be the final fit 312. Otherwise, processing may return to a previous step depending on whether a predetermined amount of time (e.g., 15 seconds) has passed since the set of quota cells was identified at step 304B. This predetermined amount of time may reflect a rate at which the quota cell priorities are updated. If it is determined, at step 318, that the time has expired, then processing may return to step 300 for a new set of quota cells having updated priorities to be identified for the panelist. Otherwise, at step 320, all of the quota cells belonging to the selected market research project may be eliminated from the set of quota cells, and processing may return to step 306 for selection of another market research project.

Turning now to FIGS. 4-6, the assignment of priorities to quota cells will be described in greater detail. Referring particularly to FIGS. 4A and 4B, the process of assigning priorities may utilize a number of predetermined values, scalars, tables of parameters. For example, referring particularly to FIG. 4B, a field schedule may be computed based upon historic patterns of when (e.g., time of day, day of week) panelists access the apparatus for matching panelists to market research projects. Values of such a field schedule may be used to determine a percentage of progress as described above. Additionally, referring particularly to FIG. 4B, a plurality of effective field time factors may be predefined for use as a function of percentage of expiration of a predetermined amount of time for completing a market research project. An example of such related factors is provided below in TABLE 1.

TABLE 1
Elapsed Effective Field Time*

| > or = | < | Factor to Insert into Algorithm** |
|---|---|---|
| 0% | 5% | 0.90 |
| 5% | 10% | 0.95 |
| 10% | 15% | 1.00 |
| 15% | 20% | 1.05 |
| 20% | 25% | 1.10 |
| 25% | 30% | 1.15 |
| 30% | 35% | 1.20 |
| 35% | 40% | 1.25 |
| 40% | 45% | 1.30 |
| 45% | 50% | 1.35 |
| 50% | 55% | 1.40 |
| 55% | 60% | 1.45 |
| 60% | 65% | 1.50 |
| 65% | 70% | 1.55 |
| 70% | 75% | 1.65 |
| 75% | 80% | 1.80 |
| 80% | 85% | 1.92 |
| 85% | 90% | 2.10 |
| 90% | 95% | 2.50 |
| 95% or more | | 3.00 |

Another set of parameters that may be predefined for use in the priority assignment may include a scarcity value (e.g., actual scarcity or a scarcity value proxy) that may be predefined for use as a function of scarcity of quota cell criteria. For example, in the case of a scarcity value proxy, a premium or charge amount may be predetermined for a targeted attribute and/or combination thereof, and a plurality of scarcity value proxy parameters may be predefined as a function of thresholds comparable to such premiums or charge amounts. An example of a such related parameters is provided below in TABLE 2.

TABLE 2
Scarcity factor = one of six values

| Scarcity | Priority | |
|---|---|---|
| Factor | Points | CPI |
| 1 | 0 | All CPI <$25 |
| 2 | 5 | n/a for now |
| 3 | 25 | n/a for now |
| 4 | 65 | CPI $25 to $50 |
| 5 | 175 | CPI $50 to $99.99 |
| 6 | 280 | CPI >$100 |

A central admin user interface may be implemented that permits the definition and editing of various parameters, values, scalars, and factors. For example, the central admin user interface may display and permit definition and editing of the effective field time factors of TABLE 1. Additionally, the central admin user interface may display and permit definition and editing of the priority points of TABLE 2. Also, the central admin user interface may display and permit editing of other values, limits (e.g., maximum and minimum limits), scalars (e.g., initial priority), and factors (e.g., tracker factor).

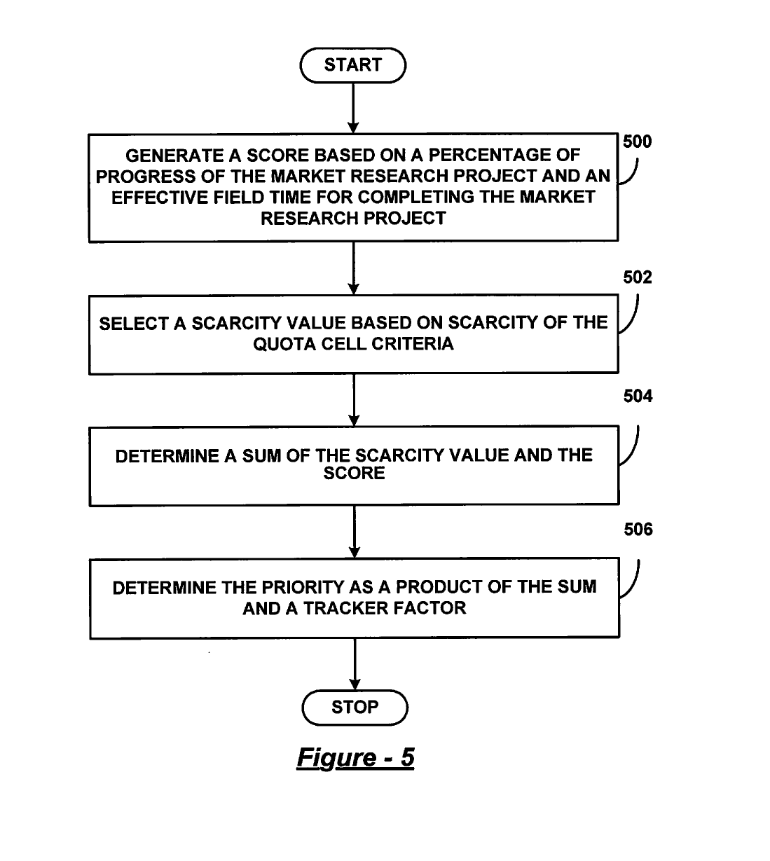

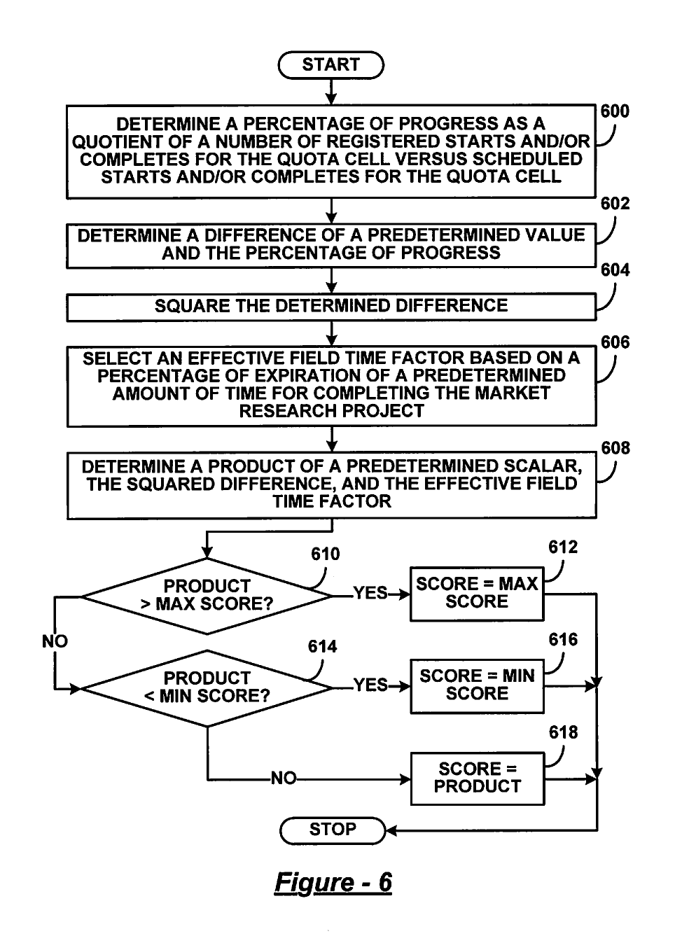

Referring particularly to FIG. 5, a method of assigning a priority to a quota cell may include, at step 500, generating a score based on a percentage of progress of the market research project, and an effective field time for completing the market research project. A method for generating such a score is explored in detail below with reference to FIG. 6. Such a method may involve imposing limits on at least one of: a percentage of progress defined in terms of number of registered versus scheduled starts and/or completes for the quota cells; or a product of the percentage of progress and an effective field time factor as described above.

Referring further to FIG. 5, the method for generating the score based on the percentage of progress may additionally include, at step 502, selecting a scarcity value, as described above, based on scarcity of the quota cell criteria. The scarcity value may be added, at step 504, to the score generated in step 500, thus generating a sum. At step 506, this sum may be scaled by a tracker factor, and the resulting product may be assigned to the quota cell as the priority of the quota cell. As mentioned above, this priority may be updated periodically (e.g., every fifteen seconds). Alternatively or additionally, the priority may be updated whenever an event occurs affecting the numbers that are used in the priority score calculation (e.g., a complete was registered in a quota cell).

Referring now particularly to FIG. 6, a method of generating the score based on the percentage of progress and the effective field time may include a set of steps, steps 600-608, that, when executed by one or more computer processors, result in a product. For example, at step 600, a percentage of progress for the quota cell may be determined by taking a quotient of a number of registered starts or completes for the quota cell, versus the number of scheduled starts or completes for that quota cell. Additionally, at step 602, a difference of a predetermined value and the percentage of progress may be determined. Also, at step 604, this difference determined at step 602 may be squared. Further, at step 606, an effective field time factor may be selected based on a percentage of expiration of a predetermined amount of time for completing the market research project. Finally, at step 608, a product of a predetermined scalar (e.g., initial priority), the squared difference, and the effective field time factor may be determined.

The method of generating the score based on the percentage of progress and the effective field time may further include comparing the aforementioned product to predetermined limits, at steps 610 and 614, and determining the generated score, at steps 612, 616, and 618, conditioned on results of the comparisons. For example, if it is determined, at step 610, the product exceeds a predetermined maximum score threshold, then the maximum score threshold may be used as the generated score at step 612. Additionally, if it is determined, at step 614, that the product falls below a predetermined minimum score threshold, then the minimum score threshold may be used as the generated score at step 616. Otherwise, the product may be used as the generated score at step 618.

From the foregoing description, one skilled in the art will readily appreciate that the procedures detailed above with reference to FIGS. 5 and 6 may carry out an algorithm for computing a priority such as the one set forth below:

```
Priority =(
          if( 450 * (1.3-Progress %)²>700
            then 700
            else if 450 * (1.3-Progress %)² * (EFT Factor)<0
              then 0
            else 450 * (1.3-Progress %)² * (EFT Factor)
            )
          + (scarcity value proxy)
        )
        * (Tracker factor)
```

In this example, the aforementioned predefined value is set at 1.3, the aforementioned predetermined scalar representing an initial priority is set at 450, and the aforementioned maximum and minimum limits are set at 750 and 0, respectively. As previously mentioned, a central admin user interface may permit display and editing of these and other parameters. Another parameter, the aforementioned tracker factor (e.g., 1.2), may also be editable via the central admin user interface.

Although the present invention and its advantages have been described in detail, it should be understood that various changes, substitutions and alterations may be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of matching a panelist to a market research project, the method comprising:
assigning, by one or more computer processors, priorities to quota cells;
accessing, by the one or more computer processors, a set of the prioritized quota cells identified for the panelist;
selecting, by the one or more computer processors, a market research project based at least in part on the priorities assigned to its respective quota cells identified for the panelist; and
matching the panelist to the market research project based on the selection.

2. The method of claim 1, wherein assigning priorities to quota cells includes assigning priorities to quota cells based on scarcity of quota cell criteria.

3. The method of claim 2, wherein assigning priorities to quota cells includes assigning the priorities based on percentage of progress of market research projects.

4. The method of claim 3, wherein assigning priorities to quota cells includes assigning the priorities based on elapsed effective field time for completion of the market research projects.

5. The method of claim 4, wherein assigning priorities includes imposing limits on at least one of:
the percentage of progress defined in terms of number of registered versus scheduled starts and/or completes for the quota cells; or
a product of the percentage of progress and an effective field time factor that reflects the elapsed effective field time based on percentage of expiration of a predetermined amount of time for completing a particular project having the quota cell.

6. The method of claim 5, wherein assigning the priorities further includes summing a result of the imposing limits with a scarcity value reflecting the scarcity of the quota cell criteria.

7. The method of claim 6, wherein assigning the priorities further comprises scaling a result of the summing by a configurable tracker factor.

8. The method of claim 7, wherein assigning the priorities comprises computing a priority according to:
Priority =(
if( 450 * (1.3-Progress %)²>700
then 700
else if 450 * (1.3-Progress %)² * (EFT Factor)<0
then 0
else 450 * (1.3-Progress %)² * (EFT Factor)
)
+ (scarcity value proxy)
)
* (Tracker factor).

9. The method of claim 4, wherein assigning the priorities based on elapsed effective field time includes employing an effective field time factor that reflects the elapsed effective field time based on percentage of expiration of a predetermined amount of time for completing a particular project having the quota cell.

10. The method of claim 3, wherein assigning the priorities based on the percentage of progress includes employing a percentage of progress defined in terms of number of registered versus scheduled starts and/or completes for the quota cells.

11. The method of claim 2, wherein assigning priorities to quota cells includes assigning the priorities based on elapsed effective field time for completion of market research projects.

12. The method of claim 1, wherein assigning the priorities to quota cells includes assigning the priorities based on percentage of progress of market research projects.

13. The method of claim 1, wherein assigning priorities to quota cells includes assigning the priorities based on elapsed effective field time for completion of the market research projects.

14. The method of claim 1, wherein selecting one of the quota cells further comprises weighting random selection of the quota cells according to the priorities assigned to the quota cells.

15. The method of claim 1, further comprising identifying the set of prioritized quota cells for the panelist by traversing a graph database in a manner constrained to profile parameter value vertices identified for the panelist, wherein the graph database relates profile parameter value vertices to quota cell vertices by edges corresponding to Boolean expressions for satisfying quota cell criteria.

16. An apparatus for matching a panelist to a market research project, the apparatus comprising:
means for assigning, by one or more computer processors, priorities to quota cells;
means for accessing, by the one or more computer processors, a set of the prioritized quota cells identified for the panelist;
means for selecting, by the one or more computer processors, a market research project based at least in part on the priorities assigned to its respective quota cells identified for the panelist; and
means for matching, by the one or more computer processors, the panelist to the market research project based on the selection.

17. The apparatus of claim 16, wherein said means for assigning priorities to quota cells includes means for assigning priorities to quota cells based on scarcity of quota cell criteria.

18. The apparatus of claim 17, wherein said means for assigning priorities to quota cells includes means for assigning the priorities based on percentage of progress of market research projects.

19. The apparatus of claim 18, wherein said means for assigning priorities to quota cells includes means for assigning the priorities based on elapsed effective field time for completion of the market research projects.

20. The apparatus of claim 19, wherein said means for assigning priorities includes means for imposing limits on at least one of:
the percentage of progress defined in terms of number of registered versus scheduled starts and/or completes for the quota cells; or
a product of the percentage of progress and an effective field time factor that reflects the elapsed effective field time based on percentage of expiration of a predetermined amount of time for completing a particular project having the quota cell.

21. The apparatus of claim 20, wherein said means for assigning the priorities further includes means for summing a result of the imposing limits with the scarcity value reflecting the scarcity of the quota cell criteria.

22. The apparatus of claim 21, wherein said means for assigning the priorities further comprises means for scaling a result of the summing by a configurable tracker factor.

23. The apparatus of claim 22, wherein said means for assigning the priorities comprises means for computing a priority according to:
Priority =(
if( 450 * (1.3-Progress %)²>700
then 700
else if 450 * (1.3-Progress %)² * (EFT Factor)<0
then 0
else 450 * (1.3-Progress %)² * (EFT Factor)
)
+ (scarcity value proxy)
)
* (Tracker factor).

24. The apparatus of claim 19, wherein said means for assigning the priorities based on elapsed effective field time includes means for employing an effective field time factor that reflects the elapsed effective field time based on percentage of expiration of a predetermined amount of time for completing a particular project having the quota cell.

25. The apparatus of claim 18, wherein said means for assigning the priorities based on the percentage of progress includes means for employing a percentage of progress defined in terms of number of registered versus scheduled starts and/or completes for the quota cells.

26. The apparatus of claim 17, wherein said means for assigning priorities to quota cells includes means for assigning the priorities based on elapsed effective field time for completion of market research projects.

27. The apparatus of claim 16, wherein said means for assigning the priorities to quota cells includes means for assigning the priorities based on percentage of progress of market research projects.

28. The apparatus of claim 16, wherein said means for assigning priorities to quota cells includes means for assigning the priorities based on elapsed effective field time for completion of the market research projects.

29. The apparatus of claim 16, wherein said means for selecting one of the quota cells further comprises means for weighting random selection of the quota cells according to the priorities assigned to the quota cells.

30. The apparatus of claim 16, further comprising means for identifying the set of prioritized quota cells for the panelist by traversing a graph database in a manner constrained to profile parameter value vertices identified for the panelist, wherein the graph database relates profile parameter value vertices to quota cell vertices by edges corresponding to Boolean expressions for satisfying quota cell criteria.

31. A computer program product, comprising:
a non-transitory computer-readable medium, comprising:
code for assigning, by one or more computer processors, priorities to quota cells;
code for accessing, by the one or more computer processors, a set of the prioritized quota cells identified for a panelist;
code for selecting, by the one or more computer processors, a market research project based at least in part on the priorities assigned to its respective quota cells identified for the panelist; and
code for matching, by the one or more computer processors, the panelist to a market research project based on the selection.

32. The computer program product of claim 31, wherein said code for assigning priorities to quota cells includes code for assigning priorities to quota cells based on scarcity of quota cell criteria.

33. The computer program product of claim 32, wherein said code for assigning priorities to quota cells includes code for assigning the priorities based on percentage of progress of market research projects.

34. The computer program product of claim 33, wherein said code for assigning priorities to quota cells includes code for assigning the priorities based on elapsed effective field time for completion of the market research projects.

35. The computer program product of claim 34, wherein said code for assigning priorities includes code for imposing limits on at least one of:
the percentage of progress defined in terms of number of registered versus scheduled starts and/or completes for the quota cells; or
a product of the percentage of progress and an effective field time factor that reflects the elapsed effective field time based on percentage of expiration of a predetermined amount of time for completing a particular project having the quota cell.

36. The computer program product of claim 35, wherein said code for assigning the priorities further includes code for summing a result of the imposing limits with a scarcity value reflecting the scarcity of the quota cell criteria.

37. The computer program product of claim 36, wherein said code for assigning the priorities further comprises code for scaling a result of the summing by a configurable tracker factor.

38. The computer program product of claim 37, wherein said code for assigning the priorities comprises code for computing a priority according to:
Priority =(
if( 450 * (1.3-Progress %)²>700
then 700
else if 450 * (1.3-Progress %)² * (EFT Factor)<0
then 0
else 450 * (1.3-Progress %)² * (EFT Factor)
)
+ (scarcity value proxy)
)
* (Tracker factor).

39. The computer program product of claim 34, wherein said code for assigning the priorities based on elapsed effective field time includes code for employing an effective field time factor that reflects the elapsed effective field time based on percentage of expiration of a predetermined amount of time for completing a particular project having the quota cell.

40. The computer program product of claim 33, wherein said code for assigning the priorities based on the percentage of progress includes code for employing a percentage of progress defined in terms of number of registered versus scheduled starts and/or completes for the quota cells.

41. The computer program product of claim 32, wherein said code for assigning priorities to quota cells includes code for assigning the priorities based on elapsed effective field time for completion of market research projects.

42. The computer program product of claim 31, wherein said code for assigning the priorities to quota cells includes code for assigning the priorities based on percentage of progress of market research projects.

43. The computer program product of claim 31, wherein said code for assigning priorities to quota cells includes code for assigning the priorities based on elapsed effective field time for completion of the market research projects.

44. The computer program product of claim 31, wherein said code for selecting one of the quota cells further comprises code for weighting random selection of the quota cells according to the priorities assigned to the quota cells.

45. The computer program product of claim 31, further comprising code for identifying the set of prioritized quota cells for the panelist by traversing a graph database in a manner constrained to profile parameter value vertices identified for the panelist, wherein the graph database relates profile parameter value vertices to quota cell vertices by edges corresponding to Boolean expressions for satisfying quota cell criteria.

46. A market research apparatus, comprising:
a memory that stores data relating to panelists and market research projects; and
a processor configured to:
assign priorities to quota cells;
access a set of the prioritized quota cells identified for the panelist;
select a market research project based at least in part on the priorities assigned to its respective quota cells identified for the panelist; and
match the panelist to the market research project based on the selection.

47. The apparatus of claim 46, wherein said processor is configured to assign priorities to quota cells at least in part based on scarcity of quota cell criteria.

48. The apparatus of claim 47, wherein said processor is configured to assign priorities to quota cells at least in part based on percentage of progress of market research projects.

49. The apparatus of claim 48, wherein said processor is configured to assign priorities to quota cells at least in part based on elapsed effective field time for completion of the market research projects.

50. The apparatus of claim 49, wherein said processor is configured to assign priorities to quota cells at least in part by imposing limits on at least one of:
the percentage of progress defined in terms of number of registered versus scheduled starts and/or completes for the quota cells; or
a product of the percentage of progress and an effective field time factor that reflects the elapsed effective field time based on percentage of expiration of a predetermined amount of time for completing a particular project having the quota cell.

51. The apparatus of claim 50, wherein said processor is configured to assign priorities to quota cells at least in part by summing a result of the imposing limits with a scarcity value reflecting the scarcity of the quota cell criteria.

52. The apparatus of claim 51, wherein said processor is configured to assign priorities to quota cells at least in part by scaling a result of the summing by a configurable tracker factor.

53. The apparatus of claim 52, wherein said processor is configured to assign priorities to quota cells at least in part by computing a priority according to:
Priority =(
if( 450 * (1.3-Progress %)²>700
then 700
else if 450 * (1.3-Progress %)² * (EFT Factor)<0
then 0
else 450 * (1.3-Progress %)² * (EFT Factor)
)
+ (scarcity value proxy)
)
* (Tracker factor).

54. The apparatus of claim 49, wherein said processor is configured to assign priorities to quota cells at least in part based on elapsed effective field time by employing an effective field time factor that reflects the elapsed effective field time based on percentage of expiration of a predetermined amount of time for completing a particular project having the quota cell.

55. The apparatus of claim 48, wherein said processor is configured to assign priorities to quota cells at least in part based on percentage of progress by employing a percentage of progress defined in terms of number of registered versus scheduled starts and/or completes for the quota cells.

56. The apparatus of claim 47, wherein said processor is configured to assign priorities to quota cells at least in part based on elapsed effective field time for completion of market research projects.

57. The apparatus of claim 46, wherein said processor is configured to assign priorities to quota cells at least in part based on percentage of progress of market research projects.

58. The apparatus of claim 46, wherein said processor is configured to assign priorities to quota cells at least in part based on elapsed effective field time for completion of the market research projects.

59. The apparatus of claim 46, wherein said processor is configured to select one of the quota cells at least in part by weighting random selection of the quota cells according to the priorities assigned to the quota cells.

60. The apparatus of claim 46, wherein said processor is configured to identify the set of prioritized quota cells for the panelist at least in part by traversing a graph database in a manner constrained to profile parameter value vertices identified for the panelist, wherein the graph database relates profile parameter value vertices to quota cell vertices by edges corresponding to Boolean expressions for satisfying quota cell criteria.

61. A method of finding a first data item within a set based on a second data item, the method comprising:
assigning, by one or more computer processors, priorities to criteria data items of the first data items, wherein the criteria data items represent criteria for matching the second data item to the first data items;
accessing, by the one or more computer processors, a set of the prioritized criteria data items identified for the second data items;
selecting, by the one or more computer processors, a first data item based at least in part on the priorities assigned to its respective criteria data items identified for the second data item; and
matching the second data item to the first data item based on the selection.

62. The method of claim 61, wherein assigning priorities to criteria data items includes assigning priorities to criteria data items based on scarcity of their respective first data items.

63. The method of claim 62, wherein assigning priorities to criteria data items includes assigning priorities to criteria data items based on schedules for finding their respective first data items.

64. The method of claim 63, wherein assigning priorities to criteria data items includes assigning priorities to criteria data items based on scarcity of second data items that satisfy the criteria of the criteria data item.

65. The method of claim 61, wherein assigning priorities to criteria data items includes assigning priorities to criteria data items based on schedules for finding their respective first data items.

66. The method of claim 65, wherein assigning priorities to criteria data items includes assigning priorities to criteria data items based on scarcity of second data items that satisfy the criteria of the criteria data item.

67. The method of claim 61, wherein assigning priorities to criteria data items includes assigning priorities to criteria data items based on scarcity of second data items that satisfy the criteria of the criteria data item.

68. An apparatus for finding a first data item within a set based on a second data item, the method comprising:
means for assigning, by one or more computer processors, priorities to criteria data items of the first data items, wherein the criteria data items represent criteria for matching the second data item to the first data items;
means for accessing, by the one or more computer processors, a set of the prioritized criteria data items identified for the second data items;
means for selecting, by the one or more computer processors, a first data item based at least in part on the priorities assigned to its respective criteria data items identified for the second data item; and
means for matching the second data item to the first data item based on the selection.

69. The apparatus of claim 68, wherein the means for assigning priorities to criteria data items includes means for assigning priorities to criteria data items based on scarcity of their respective first data items.

70. The apparatus of claim 69, wherein assigning priorities to criteria data items includes assigning priorities to criteria data items based on schedules for finding their respective first data items.

71. The method of claim 70, wherein assigning priorities to criteria data items includes assigning priorities to criteria data items based on scarcity of second data items that satisfy the criteria of the criteria data item.

72. The method of claim 68, wherein assigning priorities to criteria data items includes assigning priorities to criteria data items based on schedules for finding their respective first data items.

73. The method of claim 72, wherein assigning priorities to criteria data items includes assigning priorities to criteria data items based on scarcity of second data items that satisfy the criteria of the criteria data item.

74. The method of claim 68, wherein assigning priorities to criteria data items includes assigning priorities to criteria data items based on scarcity of second data items that satisfy the criteria of the criteria data item.
